(19) United States
(12) Patent Application Publication
(10) Pub. No.: US 2026/0186473 A1
(43) Pub. Date: Jul. 2, 2026

(54) FEEDBACK CONTROL SYSTEM AND CONTROL METHOD THEREFOR

(71) Applicant: LS ELECTRIC CO., LTD., Anyang-si, Gyeonggi-do (KR)

(72) Inventors: Yong Sub KIM, Anyang-si, Gyeonggi-do (KR); Gi Hong LEE, Anyang-si, Gyeonggi-do (KR); Joon Yeon JO, Anyang-si, Gyeonggi-do (KR); Jin Uk KIM, Anyang-si, Gyeonggi-do (KR)

(21) Appl. No.: 19/123,870

(22) PCT Filed: Jul. 20, 2023
(86) PCT No.: PCT/KR2023/010495

§ 371 Date: Apr. 24, 2025

(30) Foreign Application Priority Data
Nov. 29, 2022 (KR) 10-2022-0162467
Nov. 29, 2022 (KR) 10-2022-0162468

(51) Int. Cl. G05B 19/418

(52) U.S. Cl. CPC G05B 19/41875; G05B 19/41845

(57) ABSTRACT

A feedback control system according to one aspect of the present invention comprises: a fabrication unit that fabricates a product by reflecting a predetermined factor value; a test unit that is connected to the fabrication unit to receive the fabricated product and is configured to test the product by applying a test current to the product, and detect a result thereof; and a factor value adjustment unit that is configured to adjust the factor value by using the result detected by the test unit, wherein the result includes information about the time taken for the product to perform a predetermined action when the test current is applied, and wherein the factor value adjustment unit may be configured to compare an average value of the results of a plurality of the products with a predetermined boundary value, and adjust the factor value by using the result.

### CROSS-REFERENCE TO RELATED APPLICATIONS

The present application is a National Stage of International Application No. PCT/KR2023/010495, filed on Jul. 20, 2023, which claims priority to Korean Application No. 10-2022-0162467, filed on Nov. 29, 2022 and Korean Application No. 10-2022-0162468, filed on Nov. 29, 2022, the entire contents of each hereby incorporated by reference.

### FIELD

The present disclosure relates to a feedback control system, and more specifically, to a feedback control system that automatically feedbacks factors affecting a result of manufacturing a product to improve a degree of completion of the product, and a control method thereof.

### BACKGROUND

Many factors are involved during a process of producing or manufacturing products. By adjusting various factors, a degree of completion or quality of manufactured products may be changed. In addition, the various factors may include factors caused by environments in which products are produced. A degree of completion or quality of manufactured products may also be changed according to the environmental factors that may affect a manufacturing process.

In operating automated apparatuses, it is preferable that manufactured products have constant quality or performance. As an example, the influence of external conditions is minimized, and the various factors are adjusted, thereby achieving the consistency of the quality of products. However, it is never easy to completely control external conditions around lines in which products are manufactured.

Therefore, it is common to improve a degree of completion of products by adjusting internal factors that are easier to control, that is, factors that may be directly adjusted during a process of producing or manufacturing products.

Korean Patent Document No. 10-2030667 discloses a device for automatically testing a circuit breaker. Specifically, disclosed is a device for automatically testing a circuit breaker in which a circuit breaker is tested using a test unit, thereby improving the reliability of test results and preventing damage to the circuit breaker.

The related art document discloses that, in order to achieve desired effects, a control device can generate a feedback instruction for comparing a control result of a manufacturing process with sequence conditions of the manufacturing process and adjusting the arrangement of parts.

However, the device for automatically testing a circuit breaker disclosed in the related art document only provides a method of correcting an error in a manufacturing process. That is, the related art document does not provide a method of maintaining the quality consistency of products manufactured under the assumption that there are no errors in a manufacturing process.

Japanese Patent Publication No. 2021-190325 discloses a system for testing drawing characteristics of a circuit breaker. Specifically, disclosed is a test system in which an abnormality of an inspection device is tested using data acquired during a process prior to a test of a circuit breaker and a test process. The related art document discloses a system for testing drawing characteristics in which, after the resistance between electrodes of a completed circuit breaker is first measured, the drawing characteristics of only a circuit breaker that has been determined to have an error during the measurement are tested to test whether there is an abnormality.

However, in the system for testing drawing characteristics of a circuit breaker disclosed in the related art document, a plurality of test processes should be performed to determine whether there is an abnormality. That is, in the system for testing drawing characteristics, drawing characteristics are tested only after the resistance between the electrodes is first tested. Therefore, various apparatuses are required to perform a multi-stage test.

In addition, in the related art document, only data acquired from a process prior to a test and a test process is accumulated, but a specific method of adjusting factors affecting a process using the data is not provided.

Furthermore, the related art documents have limitations in that there is no consideration of conditions for calculating a reference for determining whether test results are suitable and a method of improving quality reliability by further correcting calculated conditions as a process progresses.
Korean Patent Document No. 10-2030667 (Oct. 2, 2019)
Japanese Patent Publication No. 2021-190325 (Dec. 13, 2021)

### SUMMARY

The present disclosure is intended to solve the above problems and is directed to providing a feedback control system capable of reflecting a result of manufacturing a product in a manufacturing process in real time, and a control method thereof.

The present disclosure is also directed to providing a feedback control system capable of automatically reflecting a result of manufacturing a product in a manufacturing process, and a control method thereof.

The present disclosure is also directed to providing a feedback control system capable of maintaining the quality of a manufactured product at a predetermined level or higher, and a control method thereof.

The present disclosure is also directed to providing a feedback system capable of reflecting a result of manufacturing consecutively manufactured products in a manufacturing process, and a control method thereof.

The present disclosure is also directed to providing a feedback control system capable of adjusting a reference for adjusting a manufacturing process and evaluating the quality of a product according to the characteristics thereof, and a control method thereof.

The objects of the present disclosure are not limited to those described above, and other objects that are not described will be clearly understood by a person skilled in the art from the description below.

According to one aspect of the present disclosure, there is provided a feedback control system including a manufacturing unit configured to manufacture products by reflecting a preset factor value, a test unit which is connected to the manufacturing unit to receive the manufactured products, apply a test current to the products to test the products, and detect results thereof, and a factor value adjustment unit configured to adjust a factor value using the results detected by the test unit, wherein the results include information about time for which the test current is applied and the product performs a preset operation, and the factor value adjustment unit is configured to compare an average value of the results of the plurality of products with a preset boundary value and adjust the factor value using a result thereof.

In this case, the feedback control system may include an average value calculation unit which is electrically connected to the test unit to receive the results and calculates an average value of the results of the plurality of products, and the average value calculation unit may include a grouping module configured to classify the plurality of products into a plurality of sets each including a preset number of the products and group the sets into a plurality of groups each including a preset number of the sets, and an average value calculation module configured to calculate the average value of the results for each group in which the plurality of products are grouped by the grouping module.

In addition, the manufacturing unit may be configured to sequentially manufacture the plurality of products, and the grouping module may be configured to, by excluding any one set including a first manufactured product among a plurality of sets included in any one group that is grouped, define a new group by adding any one set, which includes a first manufactured product among a plurality of sets included in another group subsequent to the any one group, to the any one group.

In this case, the factor value adjustment unit may include an average value comparison module configured to compare the average value calculated for each group with the preset boundary value, and a factor value calculation module configured to calculate the factor value using a size relationship between the average value calculated by the average value comparison module and the boundary value.

In addition, the preset boundary value may include an upper boundary value and a lower boundary value that is less than the upper boundary value. When the calculated average value is greater than the upper boundary value, the factor value calculation module may calculate the factor value to decrease the result, and when the calculated average value is less than the lower boundary value, the factor value calculation module may calculate the factor value to increase the result.

In this case, the feedback control system may include a boundary value calculation unit configured to calculate a boundary value using modes of the results of the plurality of products detected by the test unit, and the boundary value calculation unit may include a boundary value calculation module configured to calculate the boundary value using the mode of each of the groups in which the plurality of products are grouped.

In addition, the boundary value calculation module may calculate a largest value among the plurality of modes of the plurality of groups as an upper boundary value, may calculate a lowest value among the plurality of modes of the plurality of groups as a lower boundary value, and may calculate each of the upper and lower boundary values as a plurality of boundary values according to the number of defective products that are included in one group and do not satisfy a preset reference.

In this case, the boundary value calculation unit may include an average value trend calculation module configured to calculate information about a trend of the average value of each of the plurality of groups, and a factor value reset module configured to calculate the factor value using the information about the trend of the average value. When the information about the trend of the average value increases, the factor value reset module may calculate the factor value to decrease the average value, and when the information about the trend of the average value decreases, the factor value reset module may calculate the factor value to increase the average value.

In addition, according to one aspect of the present disclosure, there is provided a control method of a feedback control system, including operation (a) of manufacturing, by a manufacturing unit, products according to a preset factor value, operation (b) of applying, by a test unit, a test current to the manufactured products to test and evaluate the products, operation (c) of calculating, by an average value calculation unit, an average value of test results of the plurality of products, operation (d) of adjusting, by a factor value adjustment unit, the factor value using the calculated average value, and operation (e) of manufacturing, by the manufacturing unit, the products according to the adjusted factor value.

In this case, operation (b) may include operation (b1) of applying, by a test current application module, the test current to the products, operation (b2) of detecting, by a result detection module, information about time for which the products are operated by the applied test current, and operation (b3) of transmitting the information detected by the result detection module to the average value calculation unit.

In addition, operation (c) may include operation (c1) of classifying, by a grouping module, the plurality of products into a plurality of sets, operation (c2) of grouping the plurality of sets classified by the grouping module into a plurality of groups, operation (c3) of calculating, by an average value calculation module, the average value of the test results of the plurality of products included in each of the plurality of groups, and operation (c4) of transmitting, by the average value calculation module, the calculated average value to the factor value adjustment unit, and operation (c2) may include operation (c21) of grouping, by the grouping module, the plurality of sets into a preset number according to a manufacturing order, and operation (c22) of defining, by the grouping module, a new group by adding another set manufactured later than a most recently manufactured set, excluding a first manufactured set among the plurality of grouped sets.

In this case, operation (d) may include operation (d1) of comparing, by an average value comparison module, the calculated average value with a preset boundary value, operation (d2) of calculating, by a factor value calculation module, the factor value according to a size relationship between the average value and the boundary value, and operation (d3) of transmitting, by the factor value calculation module, the calculated factor value to the manufacturing unit.

In addition, the boundary value may include an upper boundary value and a lower boundary value that is less than the upper boundary value, and operation d2 may include operation (d21) of, when the average value is greater than the upper boundary value, calculating, by the factor value calculation module, the factor value to decrease the factor value, and operation (d22) of, when the average value is less than the lower boundary value, calculating, by the factor value calculation module, the factor value to increase the factor value.

In this case, the control method may include, after operation (c) and before operation (d), operation (c′) of calculating, by a boundary value calculation unit, boundary values using the test results of the plurality of products, and operation (c′) may include operation (c1′) of calculating, by the boundary value calculation module, the boundary value using a mode of the test results of the plurality of products which are grouped, operation (c2′) of comparing, by an average value trend calculation module, the calculated average value with the boundary value, and operation (c3′) of adjusting, by a factor value reset module, the factor value according to a result of comparing the average value with the boundary value.

In addition, the boundary value calculation module may calculate the plurality of boundary values according to a frequency of the boundary value, and operation (c1′) may include operation (c11′) of calculating, by the boundary value calculation module, a largest value among the plurality of boundary values of a group, which includes defective products that do not satisfy a preset reference, as an upper boundary value, and calculating, by the boundary value calculation module, a smallest value as a lower boundary value, and operation (c12′) of calculating, by the boundary value calculation module, each of the upper boundary value and the lower boundary value according to the number of defective products included in each group.

In this case, operation (c12′) may include operation (c121′) of, when the number of the defective products is a first number, calculating, by the boundary value calculation module, a first upper boundary value and a first lower boundary value, operation (c122′) of, when the number of the defective products is a second number, calculating, by the boundary value calculation module, a second upper boundary value, which is greater than the first upper boundary value, and a second lower boundary value which is less than the first lower boundary value, and operation (c123′) of, when the number of the defective products is a third number, calculating, by the boundary value calculation module a third upper boundary value, which is greater than the second upper boundary value, and a third lower boundary value which is less than the second lower boundary value.

In addition, operation (c2′) may include operation (c21′) of comparing, by the average value trend calculation module, the average value of each of a plurality of groups with the boundary value, and operation (c22′) of calculating, by the average value trend calculation module, a trend of the plurality of average values as one of an increase trend, a decrease trend, and a maintenance trend.

In this case, the boundary value calculation module may calculate the plurality of boundary values of the test results of a plurality of grouped products according to a frequency of the boundary value, and operation (c3′) may include operation (c31′) of, when the average value is greater than a largest value among the plurality of calculated boundary values, calculating, by the factor value reset module, the factor value to decrease a size of the factor value, and operation (c32′) of, when the average value is less than a smallest value among the plurality of calculated boundary values, calculating, by the factor value reset module, the factor value to increase the size of the factor value.

In addition, operation (c3′) may include operation (c33′) of, when a trend of the average value calculated by the average value trend calculation module increases, calculating, by the factor value reset module, the factor value to decrease a size of the factor value, operation (c34′) of, when the trend of the average value calculated by the average value trend calculation module decreases, calculating, by the factor value reset module, the factor value to increase the size of the factor value, and operation (c35′) of, when the trend of the average value calculated by the average value trend calculation module is maintained, calculating, by the factor value reset module, the factor value to maintain the size of the factor value.

In this case, the boundary value calculation unit may calculate a largest value among the plurality of boundary values of a group, which includes defective products that do not satisfy a preset reference, as an upper boundary value, and calculates a smallest value as a lower boundary value, and operation (d2) may include operation (d21) of, when the average value is greater than the upper boundary value, calculating, by the factor value calculation module, the factor value to decrease the factor value, and operation (d22) of, when the average value is less than the lower boundary value, calculating, by the factor value calculation module, the factor value so that the factor value increases.

According to the above configuration, in a feedback control system and a control method thereof according to embodiments of the present disclosure, a result of manufacturing a product can be reflected in a manufacturing process in real time.

The feedback control system includes a manufacturing unit. The manufacturing unit can be connected to a transfer unit to consecutively manufacture products. At least some products manufactured by the manufacturing unit are moved to a test unit to receive a test current. The test unit can detect information about operation results of the products according to the application of the test current.

The information detected by the test unit is transmitted to an average value calculation unit. The average value calculation unit calculates an average value of information detected by the test unit, that is, information about a plurality of products. The calculated average value is transmitted to a factor value adjustment unit.

The factor value adjustment unit compares the calculated average value with preset boundary values. The preset boundary values can include an upper boundary value and a lower boundary value. The factor value adjustment unit calculates the factor value by comparing the calculated average value with the upper and lower boundary values.

When the calculated average value is greater than the upper boundary value, the factor value adjustment unit calculates the factor value to decrease the average value. When the calculated average value is less than the lower boundary value, the factor value adjustment unit calculates the factor value to increase the average value. The calculated factor value can be transmitted to the manufacturing unit and can be applied to subsequent manufactured products.

Therefore, a process of testing a product and calculating a factor value according to a result thereof can be performed along with a process of manufacturing a product. Accordingly, the result of manufacturing a product can be reflected in a process of manufacturing a product in real time.

In addition, according to the above configuration, in the feedback control system and the control method thereof according to embodiments of the present disclosure, the result of manufacturing a product can be automatically reflected in a manufacturing process.

As described above, the manufacturing unit consecutively manufactures products. The average value calculation unit calculates an average value for products manufactured consecutively, and each calculated average value is transmitted to the factor value adjustment unit. The factor value adjustment unit compares a plurality of calculated average values in succession with each of the upper and lower boundary values and then calculates the factor value in real time. The calculated factor value can be transmitted to the manufacturing unit and applied to product manufacturing.

Therefore, while a process of manufacturing a product is performed, a newly calculated factor value can be automatically reflected in a newly manufactured product.

In addition, according to the above configuration, in the feedback control system and the control method thereof according to embodiments of the present disclosure, the quality of a manufactured product can be maintained at a predetermined level or more.

The feedback control system includes a boundary value calculation unit. The boundary value calculation unit calculates a boundary value using a mode of information detected by the test unit. Specifically, the boundary value calculation unit calculates the boundary value using a mode of test results in each group into which a plurality of products are grouped.

As described above, boundary values can include an upper boundary value and a lower boundary value. The boundary value calculation unit can calculate a highest value among a plurality of modes as the upper boundary value and can calculate the lowest value as the lower boundary value.

In one embodiment, the boundary value calculation unit can calculate a plurality of boundary values according to the number of defective products included in one group. In the above embodiment, the boundary value calculation unit can calculate a plurality of upper boundary values and a plurality of lower boundary values. Accordingly, an area between an upper boundary value that is the largest value and a lower boundary value that is the smallest value can be divided into a plurality of areas.

Accordingly, a calculated average value can be positioned in any one of a plurality of divided areas, an area with a value that is greater than an upper boundary value that is the largest value, and an area with a value that is less than a lower boundary value that is the smallest value.

Meanwhile, the boundary value calculation unit includes an average value trend calculation module that calculates a trend of an average value. The average value trend calculation module calculates information about a trend of an average value of consecutively manufactured products as any one of an increase trend, a decrease trend, or a maintenance trend. A factor value reset module can adjust a factor value to an increase form, a decrease form, or a maintenance form according to the calculated information about the trend of the average value. In this case, the factor value reset module can adjust the factor value to position the average value in the plurality of areas.

Therefore, a product to be manufactured can be manufactured such that an average value thereof is maintained between the maximum value that is an upper boundary value and the minimum value that is a lower boundary value. Accordingly, the quality of a product to be manufactured can be maintained at a constant level.

In addition, according to the above configuration, in the feedback control system and the control method thereof according to embodiments of the present disclosure, a manufacturing result of consecutively manufactured products can be reflected in a manufacturing process.

In one embodiment, the average value calculation unit includes a grouping module. The grouping module groups a plurality of products into a plurality of sets each including a preset number of products. In addition, the grouping module groups the plurality of sets into a plurality of groups each including a preset number of sets.

As described above, products are consecutively manufactured. Any one set including a first manufactured product among sets included in any one group is excluded, and the grouping module redefines a group by adding any one set, which includes a first manufactured product among sets included in a group subsequent to the any one group, to the any one group.

That is, each group is continuously updated by excluding one set that has been first manufactured and adding another set that is most recently manufactured.

Therefore, products consecutively manufactured can be consecutively included in any one of a plurality of groups defined consecutively. Therefore, states of products belonging to a set or group can be consecutively reflected in a manufacturing process.

In addition, according to the above configuration, in the feedback control system and the control method thereof according to embodiments of the present disclosure, a reference for adjusting a manufacturing process and evaluating the quality of a product can be adjusted according to the characteristics thereof.

As described above, a factor value calculation module or the factor value reset module calculates a factor value in a unit of a group. The calculated factor value can be transmitted to the manufacturing unit and can be applied to subsequent manufactured products. In this case, the manufacturing unit can manufacture products as many as a preset number of sets by applying a preset factor value and can manufacture products after the preset number of sets by applying a newly calculated factor value.

That is, the newly calculated factor value can be reflected after a predetermined time has elapsed. Therefore, a change in the test result of a product due to the newly calculated factor value can be calculated more clearly.

In addition, the boundary value calculation unit also calculates a new boundary value in a unit of a group. In this case, the boundary value calculation unit calculates a boundary value according to the number of defective products included in one group.

That is, a boundary value newly calculated by the boundary value calculation unit can be applied in a unit of a group. Therefore, frequent adjustment of a boundary value can be prevented, and a reference for evaluating a test result of a product can be made clearer.

As a result, a time point of calculation and application can be different according to the characteristics of a calculated factor value and boundary value.

The effects of the present disclosure are not limited to the above effects and should be understood to include all effects that may be inferred from the configuration of the present disclosure described in the detailed description or claims of the present disclosure.

### BRIEF DESCRIPTION OF THE DRAWINGS

FIG. 1 is a block diagram illustrating a configuration of a feedback control system according to an embodiment of the present disclosure.

FIG. 2 is a conceptual diagram illustrating a connection relationship between a manufacturing unit, a transfer unit, and a test unit among components of the feedback control system of FIG. 1.

FIG. 3 shows exemplary diagrams illustrating a concept of a product, a set, and a group used in the feedback control system of FIG. 1.

FIG. 4 is a block diagram illustrating an information flow formed between components of the feedback control system of FIG. 1.

FIG. 5 shows exemplary diagrams illustrating a process in which a factor value calculated by the feedback control system of FIG. 1 is applied.

FIG. 6 shows diagrams illustrating a boundary value used in the feedback control system of FIG. 1.

FIG. 7 shows diagrams illustrating a process of calculating a boundary value of FIG. 6.

FIG. 8 is a flowchart illustrating a control method of a feedback control system according to an embodiment of the present disclosure.

FIG. 9 is a flowchart illustrating the detailed flow of operation S100 of the control method of the feedback control system of FIG. 8.

FIG. 10 is a flowchart illustrating the detailed flow of operation S200 of the control method of the feedback control system of FIG. 8.

FIG. 11 is a flowchart illustrating the detailed flow of operation S300 of the control method of the feedback control system of FIG. 8.

FIG. 12 is a flowchart illustrating the detailed flow of operation S400 of the control method of the feedback control system of FIG. 8.

FIG. 13 is a flowchart illustrating the detailed flow of operation S410 of the control method of the feedback control system of FIG. 12.

FIG. 14 is a flowchart illustrating the detailed flow of operation S420 of the control method of the feedback control system of FIG. 12.

FIG. 15 is a flowchart illustrating the detailed flow of operation S430 of the control method of the feedback control system of FIG. 12.

FIG. 16 is a flowchart illustrating the detailed flow of operation S500 of the control method of the feedback control system of FIG. 8.

FIG. 17 is a flowchart illustrating the detailed flow of operation S520 of the control method of the feedback control system of FIG. 16.

FIG. 18 is a flowchart illustrating the detailed flow of operation S600 of the control method of the feedback control system of FIG. 8.

FIG. 19 is a flowchart illustrating the detailed flow of operation S700 of the control method of the feedback control system of FIG. 8.

### DETAILED DESCRIPTION

Hereinafter, embodiments of the present disclosure will be described in detail with reference to the accompanying drawings so that those skilled in the art may easily practice the present disclosure. It should be understood that the present disclosure may be embodied in different ways and is not limited to the following embodiments. In order to clearly describe the present disclosure, portions not related to the description will be omitted from the drawings. Like components will be denoted by like reference numerals throughout the specification.

Words and terms used in the present specification and claims should not be construed as being limited to a conventional or dictionary meaning and should be interpreted as a meaning and concept consistent with the technical idea of the present disclosure on the basis of the principle that an inventor can properly define the concept of terms in order to explain his or her disclosure in the best way.

Therefore, the embodiments described in the present specification and the configurations illustrated in the drawings are only exemplary embodiments of the present disclosure and do not represent all the technical ideas of the present disclosure, and thus it should be understood that there may be various equivalents and variations that can replace them at the time of application.

In the following description, descriptions of some components may be omitted to clarify the features of the present disclosure.

The term “electrical connection” as used in the following description means that one or more members are connected to each other to be able to transmit current or electrical signals. In one embodiment, the electrical connection may be performed through a wired form such as a conductor member or through a wireless form such as Bluetooth, Wi-Fi, or radio frequency identification (RFID). In one embodiment, “electrical connection” may include the meaning of “communication.”

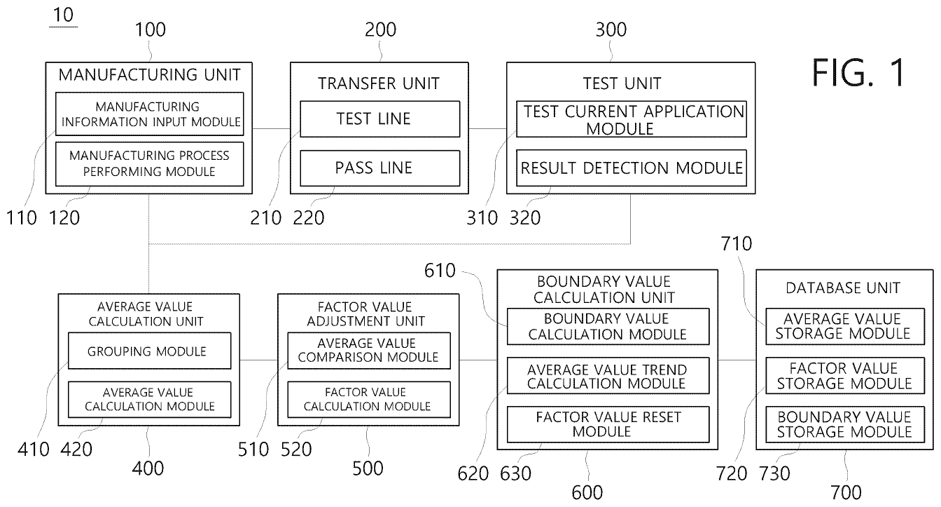

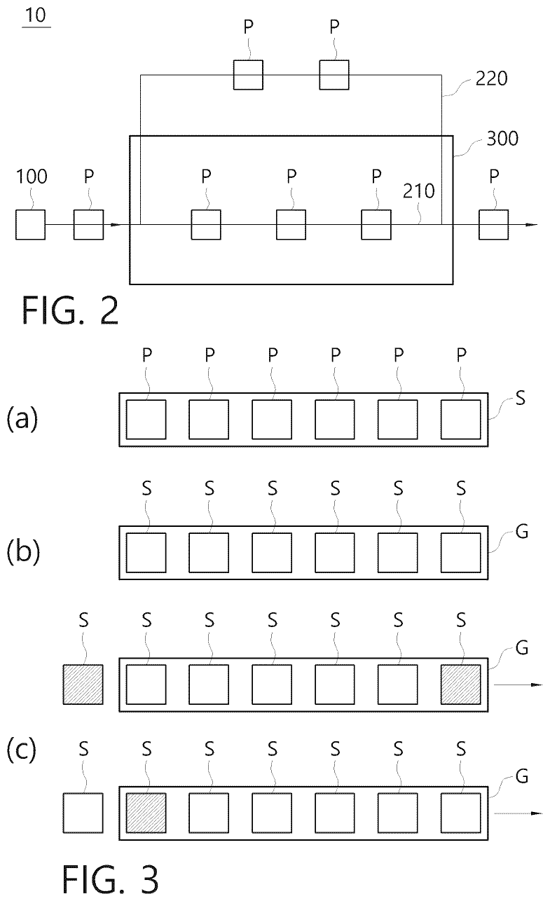

Referring to FIGS. 1 to 3, an example of a configuration of a feedback control system 10 according to an embodiment of the present disclosure is shown. The feedback control system 10 according to the embodiment of the present disclosure may perform a production process for products P.

In this case, the feedback control system 10 may store information about a factor value a that may affect the quality of the produced products P. The feedback control system 10 may adjust the factor value a to adjust the quality of the produced products P.

In addition, the feedback control system 10 may detect information related to the quality of the produced products P. The feedback control system 10 may adjust the factor value a using the detected information. Accordingly, the constant quality of products P manufactured and produced by the feedback control system 10 can be maintained.

In the following description, it is assumed that the feedback control system 10 includes components for manufacturing the products P. Alternatively, the feedback control system 10 may be provided by excluding the components for manufacturing the products P. In the above embodiment, the feedback control system 10 may be applied to a line for producing some products P and may be configured to adjust the factor value a according to a result of producing the products P.

The product P may have any form that can be manufactured automatically or manually. In one embodiment, the product P may be provided as a circuit breaker. In the above embodiment, the factor value a may include any value that can affect time T required for tripping when an overcurrent is applied to the product P.

In one embodiment, the factor value a may include any factors, such as a manufacturing environment of the product P, a material of the product P, and a resistance value of the material, which affect the time T required for tripping. For example, the factor value a may reflect the influence of any factor such as the physical properties of a bimetal, foreign materials remaining on the bimetal or the like, the condition of a welded portion (for example, the presence of burrs), a temperature and humidity around a manufacturing line, a contact condition with a terminal when an overcurrent is applied, etc.

In one embodiment, when the factor value a increases, the time T required for tripping may increase. In addition, when the factor value a decreases, the time T required for tripping may decrease.

Furthermore, the feedback control system 10 according to the embodiment of the present disclosure may analyze a quality trend of the product P according to the adjustment of the factor value a and may readjust the factor value a using the analyzed quality trend. Therefore, the factor value a may be applied to the product P by reflecting a state of the product P, which changes in real time, or the influence of a surrounding environment.

Accordingly, the consistency of quality of a plurality of products P can be secured.

In the illustrated embodiment, the feedback control system 10 includes a manufacturing unit 100, a transfer unit 200, a test unit 300, an average value calculation unit 400, a factor value adjustment unit 500, a boundary value calculation unit 600, and a database unit 700.

The manufacturing unit 100 serves to actually manufacture the product P. The manufacturing unit 100 may receive information related to a condition necessary for manufacturing the product P. The manufacturing unit 100 may manufacture the product P according to the received information.

The manufacturing unit 100 is connected to the transfer unit 200. In one embodiment, the manufacturing unit 100 may be electrically connected to the transfer unit 200. The product P manufactured by the manufacturing unit 100 may be transferred to the test unit 300 by the transfer unit 200.

The manufacturing unit 100 is electrically connected to the factor value adjustment unit 500. The manufacturing unit 100 may receive the adjusted factor value a from the factor value adjustment unit 500.

In the illustrated embodiment, the manufacturing unit 100 includes a manufacturing information input module 110 and a manufacturing process performing module 120.

The manufacturing information input module 110 receives information related to various factors for manufacturing the product P. In one embodiment, the manufacturing information input module 110 may receive the factor value a.

The manufacturing information input module 110 is electrically connected to the manufacturing process performing module 120. The manufacturing information input module 110 may transmit the input factor value a to the manufacturing process performing module 120.

The manufacturing information input module 110 is electrically connected to the factor value adjustment unit 500. The manufacturing information input module 110 may receive the factor value a calculated by the factor value adjustment unit 500.

The manufacturing information input module 110 may be provided in any form capable of inputting, storing, and outputting information. In one embodiment, the manufacturing information input module 110 may include a calculation component such as a central processing unit (CPU) or a microprocessor and a storage component such as a solid state drive (SSD), a hard disk drive (HDD), a random access memory (RAM), or a read-only memory (ROM).

Although not shown, the manufacturing information input module 110 may be electrically connected to an external terminal to receive the factor value a. Alternatively, the manufacturing information input module 110 may include a button or a touch screen and may be configured to receive the factor value a from a worker.

The manufacturing process performing module 120 manufactures the product P according to the received factor value a. The manufacturing process performing module 120 is electrically connected to the manufacturing information input module 110.

The manufacturing process performing module 120 may manufacture any product P according to the received factor value a. In one embodiment, the manufactured product P may be provided as a circuit breaker as described above.

The product P manufactured by the manufacturing process performing module 120 is transferred to the test unit 300 by the transfer unit 200. The manufacturing process performing module 120 is connected to the transfer unit 200.

The transfer unit 200 transfers the product P manufactured by the manufacturing unit 100 to an external unit. The transfer unit 200 is connected to each of the manufacturing unit 100 and the external unit.

The transfer unit 200 may be provided in any form capable of transferring the manufactured product P. In one embodiment, the transfer unit 200 may be provided in the form of a conveyor belt.

The transfer unit 200 may consist of a plurality of lines. Some lines of the plurality of lines may be connected to the external unit through the manufacturing unit 100 and the test unit 300. The products P moving along some of the lines may move to the external unit after subjected to a test process by the test unit 300.

Among the plurality of lines, other lines may each connect the manufacturing unit 100 and the external unit. The products P moving along the other lines described above may move directly to the external unit without a test process.

In the illustrated embodiment, the transfer unit 200 includes a test line 210 and a pass line 220.

The test line 210 constitutes some lines among the plurality of lines constituting the transfer unit 200. The test line 210 connects the manufacturing unit 100, the test unit 300, and the external unit. The product P manufactured by the manufacturing unit 100 may pass through the test unit 300 along the test line 210 to be subjected to a test process and then may move to the external unit.

The test line 210 is connected to the pass line 220. Specifically, the test line 210 and the pass line 220 may be provided in the form of a bypass line so that the product P manufactured by the manufacturing unit 100 may pass through the test line 210 or the pass line 220 to move to the external unit.

The pass line 220 constitutes the other lines among the plurality of lines constituting the transfer unit 200. The pass line 220 connects the manufacturing unit 100 to the external unit. The product P manufactured by the manufacturing unit 100 may pass through the pass line 220 and may move to the external unit without being subjected to a test process.

In this case, the number of products P passing through the test line 210 and the pass line 220 may be provided at a certain ratio.

That is, in the illustrated embodiment, three products P pass through the test unit 300 along the test line 210 and then move to the external unit. In addition, two products P bypass the test unit 300 and move to the external unit along the pass line 220. That is, in the embodiment, a ratio of the number of products P passing through the test unit 300 to the number of products P not passing through the test unit 300 may be determined to be 3:2.

The certain ratio may be changed according to a speed at which the manufacturing unit 100 manufactures the product P or a speed of the transfer unit 200.

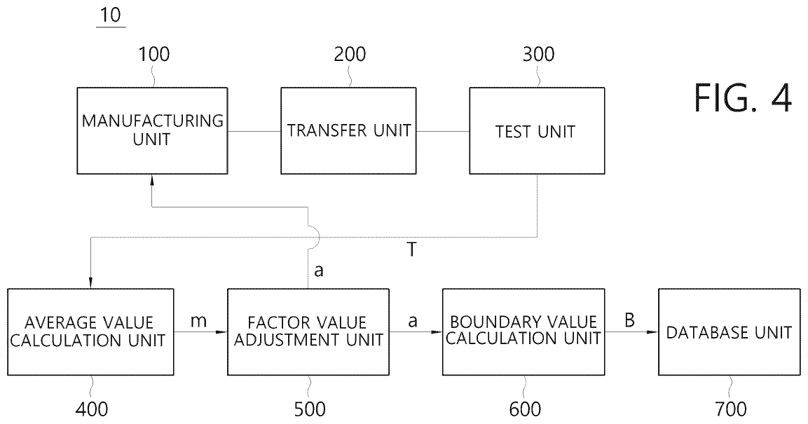

Referring to FIG. 4, the average value calculation unit 400, the factor value adjustment unit 500, the boundary value calculation unit 600, and the database unit 700 to be described below may be electrically connected to each other to transmit calculated information to each other.

In addition, the average value calculation unit 400, the factor value adjustment unit 500, the boundary value calculation unit 600, and the database unit 700 may be electrically connected directly or indirectly to the manufacturing unit 100 and the test unit 300 to exchange detected information or calculated information.

The test unit 300 tests whether the product P manufactured by the manufacturing unit 100 has been manufactured to have expected quality. A result of testing the products P by the test unit 300 is transmitted to the average value calculation unit 400 and used as basis data for adjusting the factor value a.

The test unit 300 is connected to the manufacturing unit 100 and the external unit by the transfer unit 200. The products P manufactured by the manufacturing unit 100 may pass through and be tested by the test unit 300 along the test line 210 and then may move to the external unit.

The test unit 300 is electrically connected to the average value calculation unit 400. A result of testing the products P by the test unit 300 may be transmitted to the average value calculation unit 400.

The test unit 300 may be provided in any form capable of testing the quality of the manufactured products P. In an embodiment in which the product P is provided as a circuit breaker, the test unit 300 may be configured to apply an overcurrent to the product P and detect the time T, which is required for the product P to trip, as a result.

In the illustrated embodiment, the test unit 300 includes a test current application module 310 and a result detection module 320.

The test current application module 310 applies a test current to the products P passing through the test unit 300. As described above, in one embodiment, a test current applied by the test current application module 310 may be an overcurrent. The test current application module 310 may apply a test current to each product P moved to the test unit 300.

The result detection module 320 detects an operation result of the product P to which a test current is applied by the test current application module 310.

The result detection module 320 may detect any information related to the operation result of the product P. In an embodiment in which the product P is provided as a circuit breaker and a test current is an overcurrent, the result detection module 320 may detect information about the time T required for tripping according to the application of the overcurrent.

The operation result detected by the result detection module 320 is transmitted to the average value calculation unit 400. The result detection module 320 is electrically connected to the average value calculation unit 400.

The average value calculation unit 400 calculates an average value m using a test result detected by the result detection module 320. The average value calculation unit 400 may calculate the average value m using the test result of the plurality of products P which is detected by the result detection module 320.

In an embodiment in which a test current is an overcurrent and detected information is the time T required for tripping according to the application of the overcurrent, the calculated average value m may be an average of the trip times T of the plurality of products P, which have passed through the test unit 300.

The average value calculation unit 400 may receive the test result detected by the result detection module 320. The average value calculation unit 400 is electrically connected to the result detection module 320.

The average value m calculated by the average value calculation unit 400 may be transmitted to the factor value adjustment unit 500. The average value calculation unit 400 is electrically connected to the factor value adjustment unit 500.

The average value calculation unit 400 may be provided in any form capable of inputting, calculating, and outputting information. In one embodiment, the average value calculation unit 400 may include a calculation component such as a CPU or a microprocessor.

In the illustrated embodiment, the average value calculation unit 400 includes a grouping module 410 and an average value calculation module 420.

The grouping module 410 groups the plurality of products P according to a predetermined rule. The average value calculation unit 400 may calculate the average value m for each group grouped by the grouping module 410.

Accordingly, average values m of the plurality of products P may be calculated to have regularity. As a result, since the average values m of the plurality of products P are dispersed, the risk of the factor value a being calculated inaccurately may be removed.

Referring to FIG. 3, an example of a method in which the grouping module 410 groups the plurality of products P is shown.

Referring to FIG. 3A, the plurality of products P are first classified into sets S. In the illustrated embodiment, six products P are classified into one set S.

Referring to FIG. 3B, a plurality of sets S are grouped into one group G. In the illustrated embodiment, six sets S are grouped into one group G.

The number of products P classified into one set S or the number of sets S grouped into one group G may be changed.

In this case, as the manufacturing unit 100 and the transfer unit 200 operate, the plurality of products P are consecutively moved by the transfer unit 200. That is, already manufactured products P move to the external unit, and a newly manufactured product P newly enters the transfer unit 200. Accordingly, the sets S or the group G is required to be adjusted. To this end, the grouping module 410 redefines the group G in a unit of the set S.

Referring to FIG. 3C, an example in which a process of redefining the group G as a newly manufactured product P enters is shown. In the illustrated embodiment, it will be understood that the recently manufactured products P are disposed at the left side.

At the upper side of FIG. 3C, a group G is defined to include one set S of the first manufactured products P and five sets S that are manufactured later than the one set.

At the lower side of FIG. 3C, when one set S of the first manufactured products P leaves the transfer unit 200, a group G is newly defined to include the five sets S and a last manufactured set S.

That is, the grouping module 410 may be configured to continuously redefine the group G in a unit of the set S through a shift manner.

Therefore, the average value m may be calculated for each group G newly defined in a unit of the set S. Accordingly, a problem that may occur when the average value m is calculated in a unit of the product P, that is, data overload, can be prevented. In addition, a problem that may occur when the average value m is calculated in a unit of the group G defined in order rather than in a shift manner, that is, a situation in which it is difficult to measure a state of the product P in real time, can be prevented.

A result in which the plurality of products P are grouped by the grouping module 410 is transmitted to the average value calculation module 420. The grouping module 410 is electrically connected to the average value calculation module 420.

The average value calculation module 420 calculates the average value m using a test result detected by the result detection module 320 and a result grouped by the grouping module 410.

The average value calculation module 420 is electrically connected to each of the result detection module 320 and the grouping module 410. The average value calculation module 420 may receive the detected test result and a grouped result.

The average value calculation module 420 may calculate the average value m of a test result for each of a plurality of grouped groups G. The calculated average value m for each group G is transmitted to the factor value adjustment unit 500, the boundary value calculation unit 600, and the database unit 700.

The factor value adjustment unit 500 calculates the factor value a using the calculated average value m, that is, the average value m for each group G. That is, the factor value adjustment unit 500 serves to actually adjust the factor value a according to the test result.

The factor value adjustment unit 500 may receive the average value m calculated by the average value calculation unit 400, that is, the average value m for each group G. The factor value adjustment unit 500 is electrically connected to the average value calculation unit 400.

The factor value adjustment unit 500 may receive a boundary value B calculated by the boundary value calculation unit 600. In addition, the factor value adjustment unit 500 may receive information related to the resetting of the factor value a calculated by the boundary value calculation unit 600. The factor value adjustment unit 500 is electrically connected to the boundary value calculation unit 600.

The factor value adjustment unit 500 may compare the average value m with the boundary value B. In one embodiment, the factor value adjustment unit 500 may calculate a size relationship between the average value m and the boundary value B. The factor value adjustment unit 500 may calculate the factor value a using the calculated size relationship between the average value m and the boundary value B.

The factor value a calculated by the factor value adjustment unit 500 may be transmitted to the manufacturing information input module 110 of the manufacturing unit 100. The factor value adjustment unit 500 is electrically connected to the manufacturing unit 100.

The factor value a calculated by the factor value adjustment unit 500 may be transmitted to and stored in the database unit 700. The factor value adjustment unit 500 is electrically connected to the database unit 700.

The factor value adjustment unit 500 may be provided in any form capable of inputting, calculating, and outputting information. In one embodiment, the factor value adjustment unit 500 may include a calculation component such as a CPU or a microprocessor.

In the illustrated embodiment, the factor value adjustment unit 500 includes an average value comparison module 510 and a factor value calculation module 520.

The average value comparison module 510 compares the calculated average value m, that is, the average value m for each group G, with the boundary value B. A comparison result of the average value comparison module 510 is transmitted to the factor value calculation module 520 and used to calculate the factor value a.

As will be described below, the boundary value B may include a first upper boundary value BH1, a first lower boundary value BL1, a second upper boundary value BH2, a second lower boundary value BL2, a third upper boundary value BH3, and a third lower boundary value BL3.

The average value comparison module 510 may compare the calculated average value m with a plurality of boundary values BH1, BL1, BH2, BL2, BH3, and BL3. Accordingly, whether the plurality of products P belonging to a corresponding group G are abnormal may be calculated according to a relative size relationship between the average value m and the plurality of boundary values BH1, BL1, BH2, BL2, BH3, and BL3. This will be described in detail below.

Information about the size relationship between the average value m and the boundary value B calculated by the average value comparison module 510 is transmitted to the factor value calculation module 520. The average value comparison module 510 is electrically connected to the factor value calculation module 520.

The factor value calculation module 520 calculates the factor value a using the calculated size relationship between the average value m and the boundary value B. The factor value calculation module 520 is electrically connected to the average value comparison module 510.

Specifically, when the calculated average value m is greater than the upper boundary values BH1, BH2, and BH3 of the boundary value B, the factor value calculation module 520 calculates the factor value a to decrease the factor value a. That is, the factor value calculation module 520 calculates the factor value a to decrease the time T required for tripping according to the application of a test current.

In addition, when the calculated average value m is less than the lower boundary values BL1, BL2, and BL3 of the boundary value B, the factor value calculation module 520 calculates the factor value a to increase the factor value a. That is, the factor value calculation module 520 calculates the factor value a to increase the time T required for tripping according to the application of a test current.

In addition, the factor value calculation module 520 may calculate the factor value a using information about whether to reset the factor value calculated by the boundary value calculation unit 600. The factor value a calculated by the factor value calculation module 520 is transmitted to the manufacturing unit 100 and used for the manufacturing process performing module 120 to manufacture the product P. The factor value calculation module 520 is electrically connected to the manufacturing information input module 110.

In this case, referring to FIG. 5, the factor value a newly calculated by the factor value calculation module 520 may be reflected in a set S manufactured later than a preset number of sets S.

That is, referring to FIG. 5A, even when the factor value a is newly calculated and transmitted to the manufacturing information input module 110, a preset factor value a0 may be applied to three sets S to be first manufactured. The newly calculated factor value a may be applied to the set S manufactured later than the three sets S.

Referring to FIG. 5B, the newly calculated factor value a is reflected in the set S manufactured after the manufacturing of the three sets S is completed. In the above state, when the factor value a is newly calculated, it will be understood that the three sets S positioned at a highest priority are manufactured according to the preset factor value a0, that is, the factor value a in FIG. 5A, and then the newly calculated factor value a, that is, the factor value a in FIG. 5B, is applied.

The factor value calculation module 520 may transmit the calculated factor value a to the boundary value calculation unit 600. The factor value calculation module 520 is electrically connected to the boundary value calculation unit 600.

The boundary value calculation unit 600 calculates the boundary value B that serves as a reference with which the factor value adjustment unit 500 adjusts the factor value a. The boundary value calculation unit 600 may calculate the boundary value B using a trend of the average value m calculated from a plurality of groups G.

The boundary value calculation unit 600 may receive the calculated average value m. The boundary value calculation unit 600 is electrically connected to the average value calculation unit 400.

The boundary value B calculated by the boundary value calculation unit 600 may be transmitted to the factor value adjustment unit 500. The boundary value calculation unit 600 is electrically connected to the factor value adjustment unit 500.

The boundary value B calculated by the boundary value calculation unit 600 may be transmitted to and stored in the database unit 700. The boundary value calculation unit 600 is electrically connected to the database unit 700.

The boundary value calculation unit 600 may be provided in any form capable of inputting, calculating, and outputting information. In one embodiment, the boundary value calculation unit 600 may include a calculation component such as a CPU or a microprocessor.

In the illustrated embodiment, the boundary value calculation unit 600 includes a boundary value calculation module 610, an average value trend calculation module 620, and a factor value reset module 630.

The boundary value calculation module 610 calculates the boundary value B using a mode of a test result of each group G including a plurality of sets S.

That is, one mode may be present for each group G. In addition, while the feedback control system 10 is operating, the group G is continuously redefined, and thus the average value m is calculated. Accordingly, it will be understood that the mode may be continuously calculated according to the operation of the feedback control system 10.

As described above, the boundary value B may be divided into a plurality of boundary values BH1, BL1, BH2, BL2, BH3, and BL3. To this end, the boundary value calculation module 610 may calculate each of the boundary values BH1, BL1, BH2, BL2, BH3, and BL3 based on a preset reference.

That is, the boundary value calculation module 610 may calculate the plurality of boundary values BH1, BL1, BH2, BL2, BH3, and BL3 according to the number of defective products D included in each group G. In this case, the defective product D may be defined as the product P that does not satisfy a preset reference expected when the product P is normally manufactured.

The boundary value calculation module 610 may sort calculated average values according to a number or size and may calculate the plurality of boundary values BH1, BL1, BH2, BL2, BH3, and BL3 using the calculated average values.

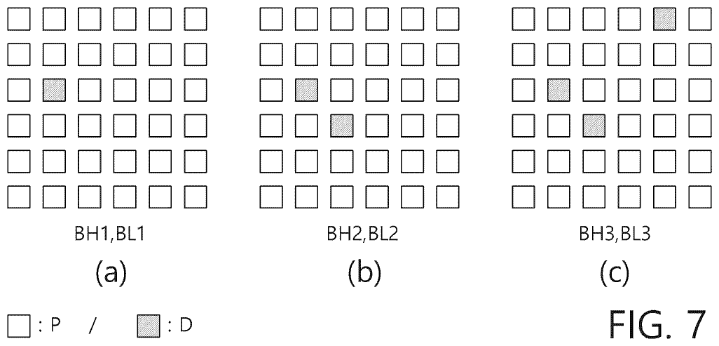

Referring to FIG. 7A, when the number of defective products D included in one group G is one, the boundary value calculation module 610 calculates the largest value among a plurality of modes as the first upper boundary value BH1 and calculates the smallest value as the first lower boundary value BL1.

Accordingly, when the calculated average value m is less than or equal to the first upper boundary value BH1 and greater than or equal to the first lower boundary value BL1, the factor value adjustment unit 500 may determine that the product P belonging to the corresponding group G is “normal.” In the above case, the factor value adjustment unit 500 may calculate the factor value a to maintain the value.

Referring to FIG. 7B, when the number of defective products D included in one group G is two, the boundary value calculation module 610 calculates the largest value among the plurality of modes as the second upper boundary value BH2 and calculates the smallest value as the second lower boundary value BL2.

Accordingly, when the calculated average value m is greater than the first upper boundary value BH1 and less than or equal to the second upper boundary value BH2 or is less than the first lower boundary value BL1 and greater than or equal to the second lower boundary value BL2, the factor value adjustment unit 500 may determine that the product P belonging to the corresponding group G is “cautious.” In the above case, the factor value adjustment unit 500 may calculate the factor value a to decrease or increase the factor value a.

Referring to FIG. 7C, when the number of defective products D included in one group G is three, the boundary value calculation module 610 calculates the largest value among the plurality of modes as the third upper boundary value BH3 and calculates the smallest value as the third lower boundary value BL3.

Accordingly, when the calculated average value m is greater than the second upper boundary value BH2 and less than or equal to the third upper boundary value BH3 or is less than the second lower boundary value BL2 and greater than or equal to the third lower boundary value BL3, the factor value adjustment unit 500 may determine that the product P belonging to the corresponding group G is “serious.” In the above case, the factor value adjustment unit 500 may calculate the factor value a to considerably decrease or increase the factor value a more.

When the calculated average value m is greater than the third upper boundary value BH3 or is less than the third lower boundary value BL3, since a deviation thereof is too excessive, the calculated average value m may be understood as meaningless data. In the above case, the factor value adjustment unit 500 may perform a calculation on the factor value a excluding the average value m.

The average value trend calculation module 620 calculates information about a trend of a change in a plurality of average values m calculated for each group G. By using the calculated information, the average value trend calculation module 620 may calculate information about an increase or decrease in the average value m according to an increase or decrease in the factor value a. Accordingly, it will be understood that the average value trend calculation module 620 may also be referred to as a factor value a trend calculation module.

The average value trend calculation module 620 calculates a trend in change of the plurality of average values m calculated from the plurality of groups G as any one of an increase trend, a decrease trend, and a maintenance trend. The trend of the average value m calculated by the average value trend calculation module 620 is transmitted to the factor value reset module 630 and used to calculate information about whether to increase, decrease, or maintain the factor value a.

The factor value reset module 630 calculates information for resetting the factor value a using information about the calculated trend of the average value m. The factor value reset module 630 may reset the factor value a such that the factor value a is increased, decreased, or maintained.

In this case, whether to increase, decrease, or maintain the factor value a according to the trend of the average value m may be determined according to a relationship between the factor value a and the average value m.

For example, it is possible to consider a proportional relationship between the factor value a and the average value m, that is, a case in which, as the factor value a increases, the average value m increases.

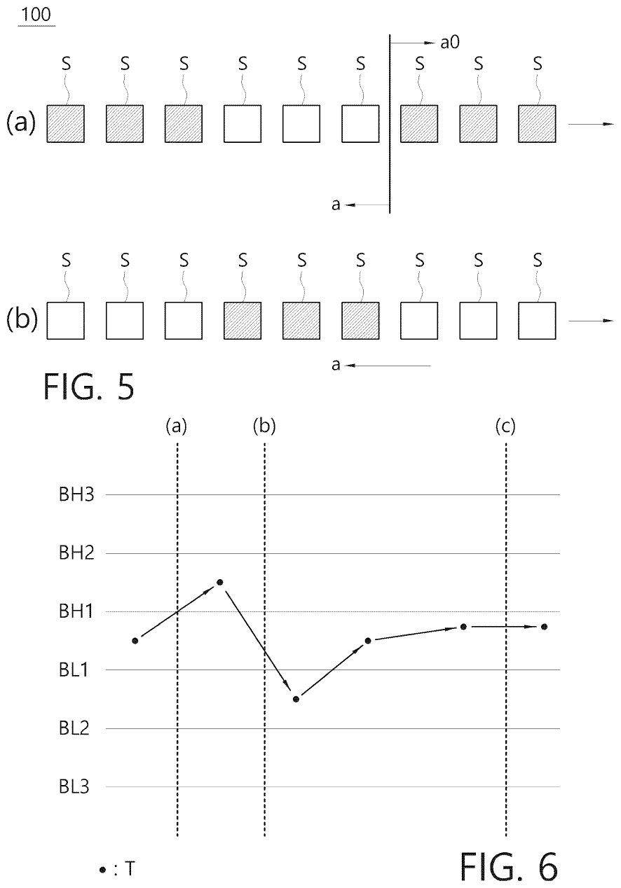

When the trend of the calculated average value m increases, the factor value reset module 630 readjusts the factor value a to decrease the factor value a (see FIG. 6A). When the trend of the calculated average value m decreases, the factor value reset module 630 readjusts the factor value a to increase the factor value a (see FIG. 6B). Furthermore, when the trend of the calculated average value m is maintained, the factor value reset module 630 readjusts the factor value a to maintain the factor value a (see FIG. 6C).

As another example, it is possible to consider an inverse relationship between the factor value a and the average value m, that is, a case in which, as the factor value a increases, the average value m decreases.

When the trend of the calculated average value m increases (see FIG. 6A), the factor value reset module 630 readjusts the factor value a to increase the factor value a. When the trend of the calculated average value m decreases (see FIG. 6B), the factor value reset module 630 readjusts the factor value a to increase the factor value a. Furthermore, when the trend of the calculated average value m is maintained (see FIG. 6C), the factor value reset module 630 readjusts the factor value a to maintain the factor value a.

Information calculated by the factor value reset module 630, that is, information for resetting the factor value a, is transmitted to the factor value adjustment unit 500 and the database unit 700.

The database unit 700 receives and stores each piece of information calculated by the average value calculation unit 400, the factor value adjustment unit 500, and the boundary value calculation unit 600. The database unit 700 may map and store each piece of received information for each group G. In the above embodiment, each group G may include information about a specification of the product P.

Therefore, information stored in the database unit 700 may be used to adjust the factor value a according to the characteristics of the product P.

The database unit 700 may include any component capable of inputting, storing, and outputting information. In one embodiment, the database unit 700 may include a CPU, a microprocessor, and an HDD, an SSD, a RAM, a ROM, a secure digital (SD), a micro-SD, or the like.

In the illustrated embodiment, the database unit 700 includes an average value storage module 710, a factor value storage module 720, and a boundary value storage module 730.

The average value storage module 710 receives and stores a result of grouping the plurality of products P calculated by the average value calculation unit 400 and the average value m for each group G. The average value storage module 710 is electrically connected to the average value calculation unit 400.

The factor value storage module 720 receives and stores information related to the resetting of the factor value a calculated by the factor value adjustment unit 500 and the factor value a calculated by the boundary value calculation unit 600. The factor value storage module 720 is electrically connected to each of the factor value adjustment unit 500 and the boundary value calculation unit 600.

The boundary value storage module 730 receives and stores the boundary value B calculated by the boundary value calculation unit 600. The boundary value storage module 730 is electrically connected to the boundary value calculation unit 600.

As described above, the boundary value calculation unit 600 may calculate a plurality of boundary values B, including the first upper boundary value BH1, the first lower boundary value BL1, the second upper boundary value BH2, the second lower boundary value BL2, the third upper boundary value BH3, and the third lower boundary value BL3. The boundary value storage module 730 may receive and store each of the plurality of calculated boundary values BH1, BL1, BH2, BL2, BH3, and BL3.

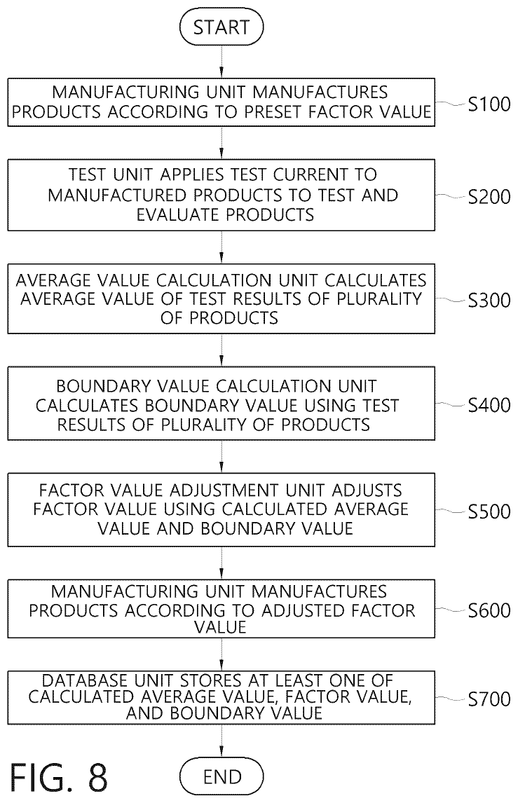

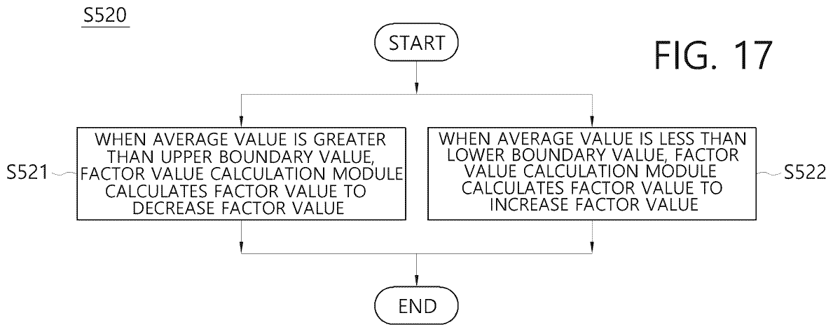

Referring to FIGS. 8 to 19, a control method of the feedback control system 10 according to an embodiment of the present disclosure is shown. The control method of the feedback control system 10 according to the embodiment may be implemented by each component of the feedback control system 10 described above.

As described above, the feedback control system 10 according to the embodiment of the present disclosure may calculate a factor value a required for manufacturing using a test result of a manufactured product P and may reflect the factor value a in a manufacturing process. That is, the feedback control system 10 may reflect and adjust factors affecting the quality of the product P in real time.

Therefore, the constant quality of products P to be manufactured can be maintained, and the occurrence of defective products D can be minimized. That is, it is possible to prevent a degradation in the quality of the product P. Furthermore, since a change in the quality of the product P according to the adjustment of the factor value a is also calculated as a trend, and thus a boundary value B, which serves as a reference for adjusting the factor value a, is also adjusted in real time, a reference for determining the quality of the product P may also be adjusted by reflecting an environment in which the product P is manufactured.

Referring to FIG. 8, the control method of the feedback control system 10 according to the embodiment includes operation S100 of manufacturing, by the manufacturing unit 100, products P according to a preset factor value a0, operation S200 of applying, by the test unit 300, a test current to the manufactured products P to test and evaluate the products P, operation S300 of calculating, by the average value calculation unit 400, an average value m of test results of the plurality of products P, operation S400 of calculating, the boundary value calculation unit 600, a boundary value B using the test results of the plurality of products P, operation S500 of adjusting, by the factor value adjustment unit 500, a factor value a using the calculated average value m and boundary value B, operation S600 of manufacturing, by the manufacturing unit 100, the products P according to the adjusted factor value a, and operation S700 of storing, by the database unit 700, at least one of the calculated average value m, factor value a, and boundary value B.

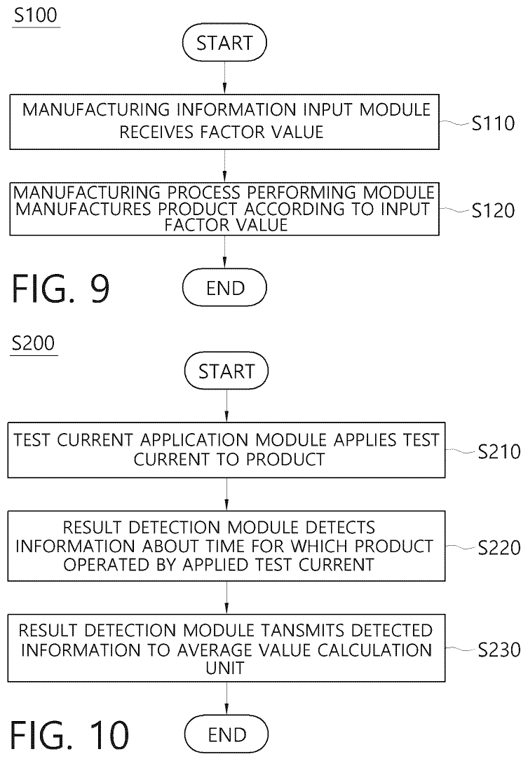

Referring to FIG. 9, the detailed flow of operation S100 of manufacturing, by the manufacturing unit 100, the products P according to the preset factor value a0 is shown. In operation S100, the manufacturing unit 100 manufactures the product P using the preset factor value a0, that is, the factor value a that has not been adjusted by the factor value adjustment unit 500.

First, the manufacturing information input module 110 receives the preset factor value a0 (S110).

In one embodiment, the manufacturing information input module 110 may receive the preset factor value a0 from the factor value adjustment unit 500 or the database unit 700. In another embodiment, the manufacturing information input module 110 may receive the preset factor value a0 from a worker through a terminal or the like. The manufacturing information input module 110 transmits the received preset factor value a0 to the manufacturing process performing module 120.

The manufacturing process performing module 120 manufactures the product P according to the input preset factor value a0. That is, the manufacturing process performing module 120 manufactures the product P according to the preset factor value a0 in which a manufacturing result or quality of the product P is not reflected.

Referring to FIG. 10, the detailed flow of operation S200 of applying, by the test unit 300, the test current to the manufactured product P to test and evaluate the product P is shown. Operation S200 is operation S200 of testing the quality of the product P manufactured by the manufacturing unit 100 and transmitting a test result to the average value calculation unit 400.

The test current application module 310 applies the test current to the manufactured product P (S210). In one embodiment, the test current applied by the test current application module 310 may be an overcurrent.

The result detection module 320 detects information about time T during which the product P is operated by the applied test current (S220). In an embodiment in which the product P is provided as a circuit breaker, the information detected by the result detection module 320 may be information about the time T during which the product P trips due to the application of an overcurrent.

The result detection module 320 transmits the detected information to the average value calculation unit 400 (S230).

In this case, as the manufacturing unit 100 and the transfer unit 200 operate, the products P may be consecutively manufactured and tested. Accordingly, in operation S200, a test may be performed on the plurality of products P that are consecutively manufactured. In addition, it will be understood that a test result detected in operation S200 may also be detected in the plurality of products P.

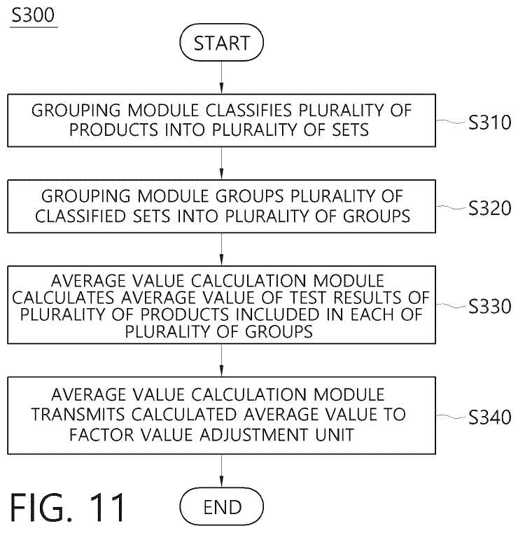

Referring to FIG. 11, the detailed flow of operation S300 of calculating, the average value calculation unit 400, the average value m of the test result of the plurality of products P is shown. Operation S300 is operation S300 of grouping a plurality of test results detected by the test unit 300 and calculating the average value m for each group G using the plurality of test results.

The grouping module 410 classifies the plurality of products P into a plurality of sets S (S310). In one embodiment, the plurality of products P may be grouped such that one set S includes six products P.

In addition, the grouping module 410 groups the plurality of sets S into a plurality of groups G (S320). In one embodiment, the plurality of sets S may be grouped such that one group G includes six sets S.

The average value calculation module 420 calculates the average value m of the test results of the plurality of products P included in each of the plurality of groups G (S330). That is, the average value calculation module 420 calculates the average value m for each group G using the test results of the plurality of products P included in each group G.

The average value calculation module 420 transmits the calculated average value m, that is, the average value m for each group G, to the factor value adjustment unit 500 (S340).

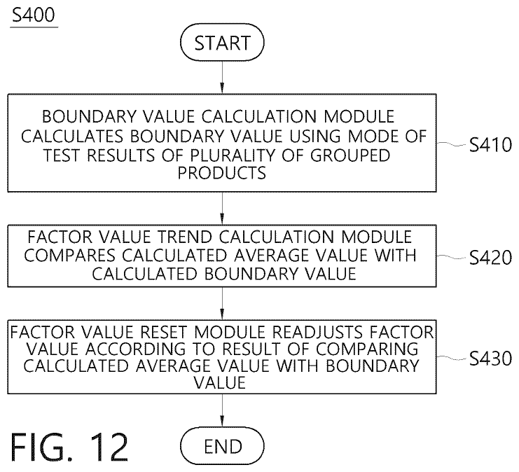

Referring to FIG. 12, the detailed flow of operation S400 of calculating, by the boundary value calculation unit 600, the boundary value B using the test results of the plurality of products P is shown. Operation S400 is operation S400 of calculating the boundary value B, which serves as the reference for determining the quality of the product P, using the average value m calculated for each group G.

First, the boundary value calculation module 610 calculates the boundary value B using a mode of the test results of the plurality of grouped products P (S410). That is, the boundary value calculation module 610 calculates the boundary value B using a test result of a high appearance frequency among the test results of the products P included in each group G. That is, the boundary value B is calculated using a size relationship between modes of different groups G each having one mode.

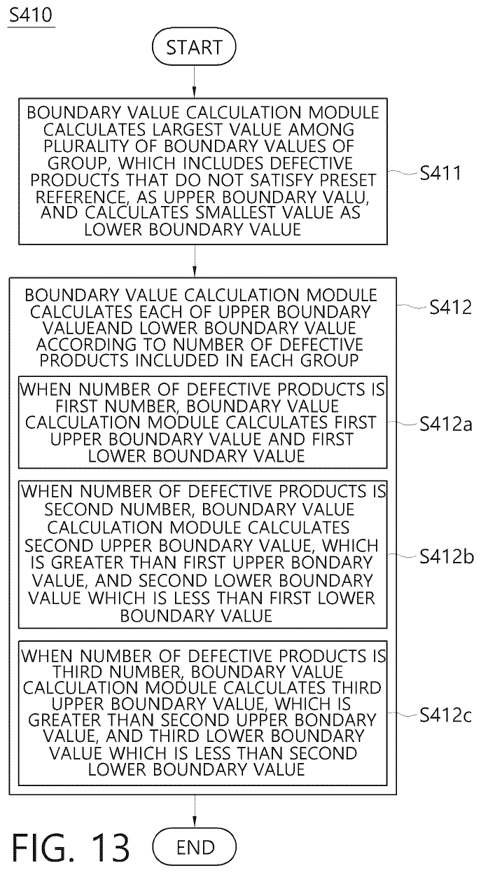

Specifically, referring to FIG. 13, the boundary value calculation module 610 calculates the largest value among a plurality of boundary values B of a group G, which includes defective products D that do not satisfy a preset reference, as an upper boundary value BH, and calculates the smallest value as a lower boundary value BL (S411).

As described above, the boundary value B calculated by the boundary value calculation module 610 may be various according to the number of defective products D included in the corresponding group G.

Accordingly, the boundary value calculation module 610 calculates each of the upper boundary value BH and the lower boundary value BL according to the number of defective products D included in each group G (S412).

Specifically, when the number of defective products D included in the group G is a first number, the boundary value calculation module 610 calculates a first upper boundary value BH1 and a first lower boundary value BL1 according to the above-described reference (S412a). In one embodiment, the first number may be one.

In addition, when the number of defective products D included in the group G is a second number, the boundary value calculation module 610 calculates a second upper boundary value BH2 and a second lower boundary value BL2 according to the above-described reference (S412b). In one embodiment, the second number may be two.

In addition, the second upper boundary value BH2 may be calculated to be greater than the first upper boundary value BH1, and the second lower boundary value BL2 may be calculated to be less than the first lower boundary value BL1. Therefore, it will be understood that a difference between the first upper boundary value BH1 and the first lower boundary value BL1 is less than a difference between the second upper boundary value BH2 and the second lower boundary value BL2.

Furthermore, when the number of defective products D included in the group G is a third number, the boundary value calculation module 610 calculates a third upper boundary value BH3 and a third lower boundary value BL3 according to the above-described reference (S412c). In one embodiment, the third number may be three.

In addition, the third upper boundary value BH3 may be calculated to be greater than the second upper boundary value BH2, and the third lower boundary value BL3 may be calculated to be less than the second lower boundary value BL2. Therefore, it will be understood that a difference between the second upper boundary value BH2 and the second lower boundary value BL2 is less than a difference between the third upper boundary value BH3 and the third lower boundary value BL3.

The calculated boundary value B is transmitted to the average value trend calculation module 620.

The average value trend calculation module 620 compares the calculated average value m with the calculated boundary value B (S420). As described above, the boundary value B may include the first to third upper boundary values BH1, BH2, and BH3 and the first to third lower boundary values BL1, BL2, and BL3. Accordingly, the average value trend calculation module 620 may compare the calculated average value m with the first to third upper boundary values BH1, BH2, and BH3 and the first to third lower boundary values BL1, BL2, and BL3.

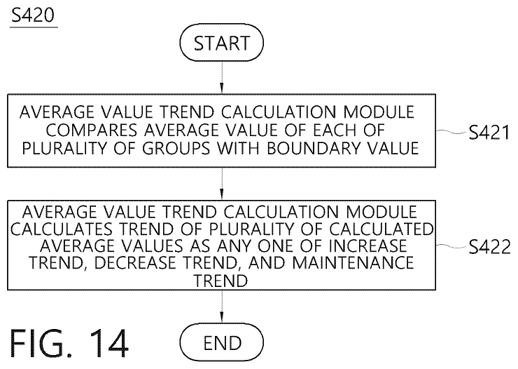

Specifically, referring to FIG. 14, the average value trend calculation module 620 compares the average value m of each of the plurality of groups G with the boundary value B (S421). In this case, the average value trend calculation module 620 may compare a trend of the calculated average value m or a plurality of average values m calculated a plurality of times with the calculated boundary value B.

In addition, the average value trend calculation module 620 calculates the trend of the plurality of calculated average values m as any one of an increase trend, a decrease trend, and a maintenance trend (S422). A result calculated by the average value trend calculation module 620 is transmitted to the factor value reset module 630.

The factor value reset module 630 readjusts the factor value a according to a result of comparing the calculated average value m with the boundary value B (S430). Operation S430 is operation S430 of calculating, by the factor value reset module 630, information about whether to increase, decrease, or maintain the factor value a.

Hereinafter, a description is based on the assumption that the factor value a and the average value m have a proportional relationship. When the factor value a and the average value m have an inverse relationship, it will be understood that an increase or decrease in the factor value a calculated by the factor value reset module 630 is opposite to an increase or decrease in the factor value a.

In one embodiment, the factor value reset module 630 may calculate the factor value a by comparing the calculated average value m with the plurality of boundary values B.

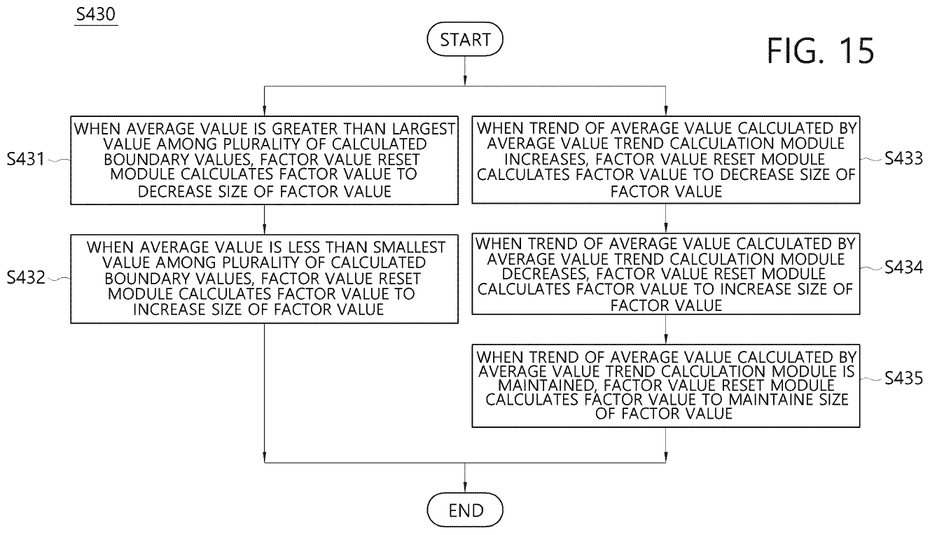

Specifically, referring to FIG. 15, when the average value m is greater than the largest value among the plurality of calculated boundary values B, the factor value reset module 630 calculates the factor value a to decrease a size of the factor value a (S431).

In this case, the largest value among the plurality of calculated boundary values B may be defined as the upper boundary value BH of the upper boundary value BH and the lower boundary value BL. That is, in operation S431, when the average value m is greater than the upper boundary value BH, in order to adjust the average value m to be less than or equal to the upper boundary value BH, the factor value reset module 630 recalculates the factor value a to decrease the size of the factor value a.

In addition, when the average value m is less than the smallest value among the plurality of calculated boundary values B, the factor value reset module 630 calculates the factor value a to increase the size of the factor value a (S432).

In this case, the smallest value among the plurality of calculated boundary values B may be defined as the lower boundary value BL of the upper boundary value BH and the lower boundary value BL. That is, in operation S431, when the average value m is greater than the upper boundary value BH, in order to adjust the average value m to be less than or equal to the upper boundary value BH, the factor value reset module 630 recalculates the factor value a to increase the size of the factor value a.

In addition, in one embodiment, the factor value reset module 630 may calculate the factor value a using the trend of the calculated average value m.

Specifically, referring to FIG. 15, when the trend of the average value m calculated by the average value trend calculation module 620 increases, the factor value reset module 630 calculates the factor value a to decrease the size of the factor value a (S433).

That is, since the factor value a and the average value m have a proportional relationship, the size of the factor value a may be decreased to adjust the average value m such that an increase trend of the average value m is slow down or the trend thereof is maintained or decreased.

In addition, when the trend of the average value m calculated by the average value trend calculation module 620 decreases, the factor value reset module 630 calculates the factor value a to increase the size of the factor value a (S434).

That is, since the factor value a and the average value m have a proportional relationship, the size of the factor value a may be increased to adjust the average value m such a decrease trend of the average value m is slow down or the trend thereof is maintained or increased.

Furthermore, when the trend of the average value m calculated by the average value trend calculation module 620 is maintained, the factor value reset module 630 calculates the factor value a to maintain the size of the factor value a (S435).

That is, since it is preferable to maintain the average value m, the factor value a may also be adjusted to be maintained.

Meanwhile, when the factor value reset module 630 calculates the factor value a using the trend of the average value m, a state before a change of the factor value a, that is, the average value m due to the preset factor value a0, is preferably positioned between the upper boundary value BH and the lower boundary value BL. More preferably, the average value m due to the preset factor value a is preferably positioned between the first upper boundary value BH1 and the first lower boundary value BL1.

As described above, this is because, in the case of the average value m positioned between the first upper boundary value BH1 and the first lower boundary value BL1, the manufactured product P may be determined to be “normal.”

That is, it will be understood that a process in which the factor value reset module 630 calculates the factor value a using the trend of the average value m is a process of adjusting the factor value a to position the average value m between the upper boundary value BH and the lower boundary value BL, preferably, between the first upper boundary value BH1 and the first lower boundary value BL1.

A calculation result of the factor value reset module 630 may be transmitted to the manufacturing information input module 110, the factor value calculation module 520, or the factor value storage module 720.

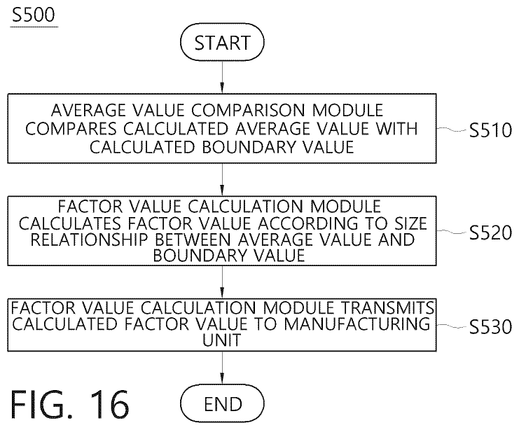

Referring to FIG. 16, the detailed flow of operation S500 of adjusting, by the factor value adjustment unit 500, the factor value a using the calculated average value m and boundary value B is shown. Operation S500 is operation S500 of newly calculating, by the factor value adjustment unit 500, the factor value a based on the test result of each product P and the calculated boundary value B.

The average value comparison module 510 compares the calculated average value m with the calculated boundary value B (S510). In this case, the average value m and the boundary value B may be respectively calculated by the average value calculation unit 400 and the boundary value calculation unit 600 and transmitted to the average value comparison module 510.

The factor value calculation module 520 calculates the factor value a according to a size relationship between the average value m and the boundary value B (S520).

Specifically, when the calculated average value m is greater than the upper boundary value BH, the factor value calculation module 520 calculates the factor value a to decrease the factor value a (S521).

In addition, when the calculated average value m is greater than the lower boundary value BL, the factor value calculation module 520 calculates the factor value a to increase the factor value a (S522).

That is, it will be understood that a process in which the factor value reset module 630 calculates the factor value a using the upper boundary value BH and the lower boundary value BL, that is, the trend of the average value m is also a process of adjusting the factor value a to position the average value m between the upper boundary value BH and the lower boundary value BL, preferably, between the first upper boundary value BH1 and the first lower boundary value BL1.

Although not shown, the factor value calculation module 520 may further calculate the factor value a using a calculation result of the factor value reset module 630, that is, information for adjusting the factor value a such that the factor value a is increased, decreased, or maintained.

The factor value calculation module 520 transmits the calculated factor value a to the manufacturing information input module 110 of the manufacturing unit 100 (S530).

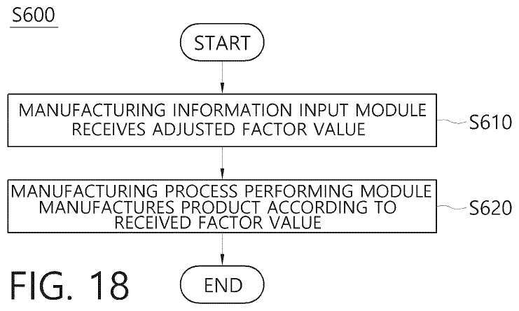

Referring to FIG. 18, the detailed flow of operation S600 of manufacturing, by the manufacturing unit 100, the product P according to the adjusted factor value a is shown. Operation S600 is operation S600 of manufacturing, by the manufacturing unit 100, the product P by reflecting the factor value a calculated by reflecting a test result of an already manufactured product P.

The manufacturing information input module 110 receives the factor value a calculated by the factor value adjustment unit 500 or the boundary value calculation unit 600 (S610). The manufacturing process performing module 120 manufactures the product P according to the received factor value a (S620).

In this case, as described above, the manufacturing process performing module 120 may manufacture a preset number of sets S according to the preset factor values a0 and may manufacture subsequent sets S according to the received factor values a.

It will be understood that the product P manufactured by reflecting the newly calculated factor value a may also be moved to the test unit 300 by the transfer unit 200 so that a test of the product P may be performed, and a test result thereof may be detected.

Therefore, in the feedback control system 10 according to the embodiment of the present disclosure, during a process of manufacturing the product P, the factor value a may be calculated and feedbacked continuously and in real time and reflected in the manufacturing of the product P.

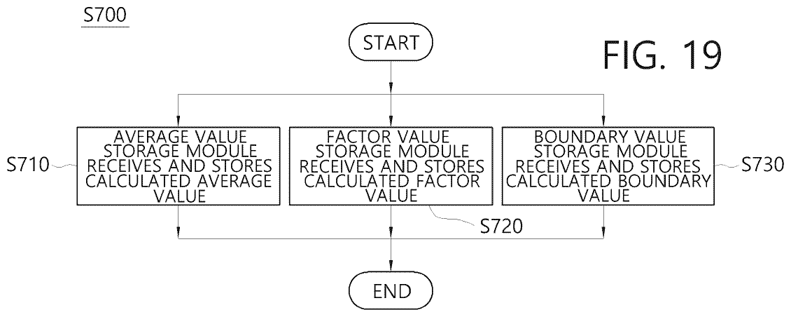

Referring to FIG. 19, the detailed flow of operation S700 of storing, by the database unit 700, at least one of the calculated average value m, factor value a, and boundary value B is shown. Operation S700 is operation S700 in which the database unit 700 receives and stores the average value m calculated by the average value calculation unit 400, the factor value a calculated by the factor value adjustment unit 500, and the boundary value B calculated by the boundary value calculation unit 600.

The average value storage module 710 receives and stores the average value m calculated by the average value calculation module 420 (S710). The factor value storage module 720 receives and stores the factor value a calculated by the factor value calculation module 520 or the factor value reset module 630 (S720). The boundary value storage module 730 receives and stores the boundary value B calculated by the boundary value calculation module 610 (S730).

The average value m, the factor value a, and the boundary value B stored in the database unit 700 may each be stored by being mapped to the serial number, specification, or the like of the product P.

While the present disclosure has been described with reference to embodiments, the spirit of the present disclosure is not limited to the embodiments presented in the present specification. Those skilled in the art who understand the spirit of the present disclosure may easily suggest other embodiments by adding, changing, or deleting components within the scope of the same concept, and the other embodiments are also within the spirit of the present disclosure.

| | |
|---|---|
| 10: feedback control system | 100: manufacturing unit |
| 110: manufacturing information | 120: manufacturing process |
| input module performing module | |
| 200: transfer unit | 210: test line |
| 220: pass line | 300: test unit |
| 310: test current application | 320: result detection module |
| module | |
| 400: average value calculation | 410: grouping module |
| unit | |
| 420: average value calculation | 500: factor value adjustment unit |
| module | |
| 510: average value comparison | 520: factor value calculation |
| module | module |
| 600: boundary value calculation | 610: boundary value calculation |
| unit | module |
| 620: average value trend | 630: factor value reset module |
| calculation module | |
| 700: database unit | 710: average value storage module |
| 720: factor value storage | 730: boundary value storage module |
| module | |
| 720: factor value storage | 730: boundary value storage module |
| module | |
| P: product | D: defective product |
| S: set | G: group |
| a: factor value | a0: preset factor value |
| m: average value | T: time |
| B: boundary value | BH1: first upper boundary value |
| BL1: first lower boundary value | BH2: second upper boundary value |
| BL2: second lower boundary value | BH3: third upper boundary value |
| BL3: third lower boundary value | |

What is claimed is:

2. A feedback control system comprising:
a manufacturing unit configured to manufacture products by reflecting a preset factor value;
a test unit which is connected to the manufacturing unit to receive the manufactured products, apply a test current to the products to test the products, and detect results thereof; and
a factor value adjustment unit configured to adjust a factor value using the results detected by the test unit,
wherein the results include information about time for which the test current is applied and the product performs a preset operation, and
the factor value adjustment unit is configured to compare an average value of the results of the plurality of products with a preset boundary value and adjust the factor value using a result thereof.

2. The feedback control system of claim 1, comprising an average value calculation unit which is electrically connected to the test unit to receive the results and calculates an average value of the results of the plurality of products,
wherein the average value calculation unit includes:
a grouping module configured to classify the plurality of products into a plurality of sets each including a preset number of the products and group the sets into a plurality of groups each including a preset number of the sets; and
an average value calculation module configured to calculate the average value of the results for each group in which the plurality of products are grouped by the grouping module.

3. The feedback control system of claim 2, wherein the manufacturing unit is configured to sequentially manufacture the plurality of products, and
the grouping module is configured to, by excluding any one set including a first manufactured product among a plurality of sets included in any one group that is grouped, define a new group by adding any one set, which includes a first manufactured product among a plurality of sets included in another group subsequent to the any one group, to the any one group.

4. The feedback control system of claim 2, wherein the factor value adjustment unit includes:
an average value comparison module configured to compare the average value calculated for each group with the preset boundary value; and
a factor value calculation module configured to calculate the factor value using a size relationship between the average value calculated by the average value comparison module and the boundary value.

5. The feedback control system of claim 4, wherein:
the preset boundary value includes an upper boundary value and a lower boundary value that is less than the upper boundary value; and
when the calculated average value is greater than the upper boundary value, the factor value calculation module calculates the factor value to decrease the result, and when the calculated average value is less than the lower boundary value, the factor value calculation module calculates the factor value to increase the result.

6. The feedback control system of claim 1, comprising a boundary value calculation unit configured to calculate a boundary value using modes of the results of the plurality of products detected by the test unit,
wherein the boundary value calculation unit includes a boundary value calculation module configured to calculate the boundary value using the mode of each of the groups in which the plurality of products are grouped.

7. The feedback control system of claim 6, wherein the boundary value calculation module calculates a largest value among the plurality of modes of the plurality of groups as an upper boundary value, calculates a lowest value among the plurality of modes of the plurality of groups as a lower boundary value, and calculates each of the upper and lower boundary values as a plurality of boundary values according to the number of defective products that are included in one group and do not satisfy a preset reference.

8. The feedback control system of claim 6, wherein:
the boundary value calculation unit includes an average value trend calculation module configured to calculate information about a trend of the average value of each of the plurality of groups, and a factor value reset module configured to calculate the factor value using the information about the trend of the average value; and
when the information about the trend of the average value increases, the factor value reset module calculates the factor value to decrease the average value, and when the information about the trend of the average value decreases, the factor value reset module calculates the factor value to increase the average value.

9. A control method of a feedback control system, comprising:
operation (a) of manufacturing, by a manufacturing unit, products according to a preset factor value;
operation (b) of applying, by a test unit, a test current to the manufactured products to test and evaluate the products;
operation (c) of calculating, by an average value calculation unit, an average value of test results of the plurality of products;
operation (d) of adjusting, by a factor value adjustment unit, the factor value using the calculated average value; and
operation (e) of manufacturing, by the manufacturing unit, the products according to the adjusted factor value.

10. The control method of claim 9, wherein operation (b) includes:
operation (b1) of applying, by a test current application module, the test current to the products;
operation (b2) of detecting, by a result detection module, information about time for which the products are operated by the applied test current; and
operation (b3) of transmitting the information detected by the result detection module to the average value calculation unit.

11. The control method of claim 9, wherein operation (c) includes:
operation (c1) of classifying, by a grouping module, the plurality of products into a plurality of sets;
operation (c2) of grouping the plurality of sets classified by the grouping module into a plurality of groups;
operation (c3) of calculating, by an average value calculation module, the average value of the test results of the plurality of products included in each of the plurality of groups; and
operation (c4) of transmitting, by the average value calculation module, the calculated average value to the factor value adjustment unit,
wherein operation (c2) includes:
operation (c21) of grouping, by the grouping module, the plurality of sets into a preset number according to a manufacturing order; and
operation (c22) of defining, by the grouping module, a new group by adding another set manufactured later than a most recently manufactured set, excluding a first manufactured set among the plurality of grouped sets.

12. The control method of claim 9, wherein operation (d) includes:
operation (d1) of comparing, by an average value comparison module, the calculated average value with a preset boundary value;
operation (d2) of calculating, by a factor value calculation module, the factor value according to a size relationship between the average value and the boundary value; and
operation (d3) of transmitting, by the factor value calculation module, the calculated factor value to the manufacturing unit.

13. The control method of claim 12, wherein the boundary value includes an upper boundary value and a lower boundary value that is less than the upper boundary value, and
operation d2 includes operation (d21) of, when the average value is greater than the upper boundary value, calculating, by the factor value calculation module, the factor value to decrease the factor value, and operation (d22) of, when the average value is less than the lower boundary value, calculating, by the factor value calculation module, the factor value to increase the factor value.

14. The control method of claim 12, comprising, after operation (c) and before operation (d), operation (c′) of calculating, by a boundary value calculation unit, boundary values using the test results of the plurality of products,
wherein operation (c′) includes:
operation (c1′) of calculating, by the boundary value calculation module, the boundary value using a mode of the test results of the plurality of products which are grouped;
operation (c2′) of comparing, by an average value trend calculation module, the calculated average value with the boundary value; and
operation (c3′) of adjusting, by a factor value reset module, the factor value according to a result of comparing the average value with the boundary value.

15. The control method of claim 14, wherein the boundary value calculation module calculates the plurality of boundary values according to a frequency of the boundary value, and
operation (c1′) includes operation (c11′) of calculating, by the boundary value calculation module, a largest value among the plurality of boundary values of a group, which includes defective products that do not satisfy a preset reference, as an upper boundary value, and calculating, by the boundary value calculation module, a smallest value as a lower boundary value, and operation (c12′) of calculating, by the boundary value calculation module, each of the upper boundary value and the lower boundary value according to the number of defective products included in each group.

16. The control method of claim 15, wherein operation (c12′) includes:
operation (c121′) of, when the number of the defective products is a first number, calculating, by the boundary value calculation module, a first upper boundary value and a first lower boundary value;
operation (c122′) of, when the number of the defective products is a second number, calculating, by the boundary value calculation module, a second upper boundary value, which is greater than the first upper boundary value, and a second lower boundary value which is less than the first lower boundary value; and
operation (c123′) of, when the number of the defective products is a third number, calculating, by the boundary value calculation module a third upper boundary value, which is greater than the second upper boundary value, and a third lower boundary value which is less than the second lower boundary value.

17. The control method of claim 14, wherein operation (c2′) includes:
operation (c21′) of comparing, by the average value trend calculation module, the average value of each of a plurality of groups with the boundary value; and
operation (c22′) of calculating, by the average value trend calculation module, a trend of the plurality of average values as one of an increase trend, a decrease trend, and a maintenance trend.

18. The control method of claim 14, wherein the boundary value calculation module calculates the plurality of boundary values of the test results of a plurality of grouped products according to a frequency of the boundary value, and operation (c3′) includes operation (c31′) of, when the average value is greater than a largest value among the plurality of calculated boundary values, calculating, by the factor value reset module, the factor value to decrease a size of the factor value, and operation (c32′) of, when the average value is less than a smallest value among the plurality of calculated boundary values, calculating, by the factor value reset module, the factor value to increase the size of the factor value.

19. The control method of claim 14, wherein operation (c3′) includes:
operation (c33′) of, when a trend of the average value calculated by the average value trend calculation module increases, calculating, by the factor value reset module, the factor value to decrease a size of the factor value;
operation (c34′) of, when the trend of the average value calculated by the average value trend calculation module decreases, calculating, by the factor value reset module, the factor value to increase the size of the factor value; and
operation (c35′) of, when the trend of the average value calculated by the average value trend calculation module is maintained, calculating, by the factor value reset module, the factor value to maintain the size of the factor value.

20. The control method of claim 19, wherein the boundary value calculation unit calculates a largest value among the plurality of boundary values of a group, which includes defective products that do not satisfy a preset reference, as an upper boundary value, and calculates a smallest value as a lower boundary value, and operation (d2) includes operation (d21) of, when the average value is greater than the upper boundary value, calculating, by the factor value calculation module, the factor value to decrease the factor value, and operation (d22) of, when the average value is less than the lower boundary value, calculating, by the factor value calculation module, the factor value so that the factor value increases.
